(19) United States
(12) Patent Application Publication
(10) Pub. No.: US 2025/0345784 A1
(43) Pub. Date: Nov. 13, 2025

(54) SPINEL SORBENT COMPOUND

(71) Applicant: E3 LITHIUM LTD., Calgary (CA)

(72) Inventors: Munish SHARMA, Calgary (CA); Pritam SAHA, Calgary (CA)

(21) Appl. No.: 18/867,919

(22) PCT Filed: May 25, 2023
(86) PCT No.: PCT/CA2023/050714

§ 371 Date: Nov. 21, 2024

Related U.S. Application Data
(60) Provisional application No. 63/346,484, filed on May 27, 2022.

(51) Int. Cl. B01J 39/10; B01J 39/02; B01J 49/53; C01G 45/1221; C02F 1/42; C02F 101/10; C22B 3/24; C22B 26/12

(52) U.S. Cl. CPC B01J 39/10; B01J 39/02; B01J 49/53; C01G 45/1221; C02F 1/42; C22B 3/24; C22B 26/12; C01P 2002/32; C01P 2002/52; C01P 2002/72; C01P 2002/76; C01P 2002/77; C01P 2002/78; C01P 2002/88; C02F 2001/425; C02F 2101/10; C02F 2303/16

(57) ABSTRACT

A spinel sorbent for adsorbing lithium ions from a liquid is provided. The sorbent has the general formula Li_{1 +x}Mn_{2-y}M1ₘ₁M2ₘ₂ . . . MkₘₖO_{4+z}, where M1, M2, . . . , Mk are cations different than lithium or manganese; m1, m2, . . . mk are each greater than or equal to 0; x can vary in the range of 0 and 1; y can vary in the range of −0.1 and 0.9; z can vary in the range of −2 and 1; where +m1+m2+ . . . +mk; and k is zero or a positive integer. The sorbent has a cubic close packed (CPP) lattice defining a interplanar distance y=x configured to allow passage of lithium ions through the interplanar distance and prevent passage of manganese through the interplanar distance; and has ion exchange sites configured to reversibly ion-exchange a lithium ion.

### CROSS REFERENCE TO RELATED APPLICATIONS

This application claims the benefit of priority to U.S. Provisional Patent Application No. 63/346,484, filed May 27, 2022, the disclosure of which is incorporated by reference herein in its entirety.

### TECHNICAL FIELD

The disclosure relates generally to extraction of lithium from liquid, and more particularly to sorbent compounds useful in the extraction of lithium from liquid sources such as brines, and leachate solutions.

### BACKGROUND

Lithium (Li) has emerged as a critical resource in the clean energy transition and may be used in Li-related products and for further fabricating electric energy-storage products, e.g., lithium ion batteries. Brine, such as salt lake brines, containing lithium may be used as a source of lithium. Existing brine extraction methods often make use of salt flats where solar evaporation ponds are created to separate the lithium minerals from the brine. These evaporation processes can be very time-consuming often taking several months or even years to achieve the separation. Further, brines may contain different compounds and ions such as magnesium (Mg), and separating lithium from the other compounds and ions such as magnesium (Mg) may be difficult.

### SUMMARY

This disclosure provides a spinel sorbent compound and methods of making the sorbent. The sorbent may be used to extract lithium from brine or a leachate solution.

In one aspect, the disclosure describes a spinel sorbent for adsorbing lithium ions from a liquid, the sorbent comprising:

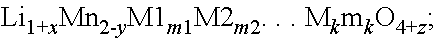

wherein:
M1, M2, . . . , Mk are cations different than lithium or manganese;
m1, m2, . . . mk are each greater than or equal to 0;
x can vary in the range of 0 and 1;
y can vary in the range of −0.1 and 0.9;
z can vary in the range of −2 and 1;
where y=x+m1+m2+ . . . +mk; and
k is zero or a positive integer;
the sorbent having a cubic close packed (CPP) lattice defining a interplanar distance configured to allow passage of lithium ions through the interplanar distance and prevent passage of manganese through the interplanar distance; and
the sorbent having ion exchange sites, each ion exchange site configured to reversibly ion-exchange a lithium ion.

In an embodiment, M1, M2, . . . , Mk comprise at least one of boron group metals, transition metals, alkali metals and alkaline earth metals.

In an embodiment, M1, M2, . . . , Mk comprise at least one of B, Mg, Al, Fe, Cu, Ag, Sn, V, Ni, Co, Ti, Si, or Zn, or combinations thereof. In particular embodiments, M1, M2, . . . , Mk comprise Ni, Co, Al, V, B, Mg, or combinations thereof, such as the combination of Ni and Co.

During synthesis of exemplary spinel sorbents, lithium may be provided as LiOH·H₂O; manganese may be provided as MnCO₃; nickel may be provided as Ni₃CO₃·5H₂O (nickel carbonate basic hydrate), Ni(NO₃)₂, or a combination thereof; cobalt may be provided as Co(NO₃)₂·6H₂O, CoCO₃·H₂O (cobalt carbonate hydrate), CoCO₃, or any combination thereof; aluminum may be provided as Al(NO₃)₃·9H₂O (aluminum nitrate nonahydrate), Al(OH)₃, or any combination thereof; vanadium may be provided as V₂O₅; boron may be provided as H₃BO₃; and magnesium may be provided as Mg(NO₃)₂·6H₂O.

In various embodiments, the ratio of Li/Mn may be from about 0.8:1 to about 3.0:1. In some embodiments, the ratio of Li/Mn may be from about 1.1:1 to about 3.0:1. In various examples, the ratio of Li/Mn may be about 0.8:1, about 1.1:1, about 1.17:1, about 1.27:1, about 1.5:1, or about 3.0:1.

In an embodiment, the interplanar distance is 0.01-0.46 nm. In another embodiment, the interplanar distance is 0.01-0.2 nm. In another embodiment, the interplanar distance is 0.01-0.1 nm.

In an embodiment, Li+ cations occupy tetrahedral sites of the CCP lattice and an equal proportion of Mn ions occupy octahedral sites of the CCP lattice.

In an embodiment, the CCP lattice defines a tunnel, the ion exchange sites facing the tunnel. In another embodiment, an intercalation distance of the tunnel is smaller than the interplanar distance. In another embodiment, the CCP lattice comprises a LiO₄ tetrahedra site connected to a MnO₆ octahedra site for allowing passage of lithium ions through the interplanar distance of the CCP lattice and prevents any other ion in the liquid from accessing ion exchange sites in the lattice.

In an embodiment, the Mn of the spinel sorbent comprises species having different oxidation states including at least one of MnO (Mn²⁺), MnO₂ (Mn⁴⁺), Mn₂O₃ (Mn³⁺), Mn₃O₄ (Mn²⁺, Mn³⁺). In various embodiments, the average oxidation state of the Mn in the spinel sorbent approaches 4.0. For example, the average oxidation state may be from 3.9 to 3.99.

In an embodiment, the cubic close packed (CPP) lattice is a simple cubic structure, a body-centered cubic structure, or a face-centred cubic structure (fcc).

In an embodiment, in a calcined form the spinel sorbent comprises 1-50 wt % lithium. In another embodiment, the spinel sorbent comprises 1-30 wt % lithium. In another embodiment, the spinel sorbent comprises 1-10 wt % lithium.

Embodiments may include combinations of the above features.

In another aspect, the disclosure describes a method comprising: providing any one of spinel sorbents according to this disclosure; combining the spinel sorbent with a liquid comprising lithium ions; filtering the spinel sorbent from the liquid; and desorbing lithium ions from the spinel sorbent at a first pH and a first temperature.

In an embodiment, the method comprises exchanging H+ with Li+ at ion exchange sites of the spinel sorbent.

In an embodiment, the first pH about −0.5-7.0. In another embodiment, the first pH is about 0.1-4.0 at 20-100 deg C.

In an embodiment, the method comprises adsorbing lithium ion on the spinel sorbent at a second pH of about 4.0-10.0. In an embodiment, the second pH is 6.0-10.0 at 20-85 deg C.

In an embodiment, the method comprises combining the spinel sorbent with a second liquid comprising lithium ions, filtering the spinel sorbent from the second liquid; and desorbing lithium ions from the spinel sorbent after filtering the spinel sorbent from the second liquid. In another embodiment, the first liquid is the same as the second liquid.

Embodiments may include combinations of the above features.

In another aspect, the disclosure describes a method comprising: i) mixing, in a solid state or in a slurry state, a lithium-containing compounds, a manganese compound, and optionally a compound containing a metal element different than lithium or manganese, such as a metal element as discussed above; ii) dry pulverizing one of the reagents or mixture to achieve a certain particle size; iii) performing heat-treatment in a single stage or multiple stages; iv) wet size classification post heat-treatment; iv) acid treatment; v) rinsing the excess reagent off the sorbent surface; vi) drying the sorbent material; vii) heat treating the dried sorbent material and degassing.

Further details of these and other aspects of the subject matter of this application will be apparent from the detailed description included below and the drawings.

### DESCRIPTION OF THE DRAWINGS

Reference is now made to the accompanying drawings, in which:

FIG. 1 shows a ball and stick representation of an example spinel sorbent;

FIG. 2 shows a polyhedral representation an example spinel sorbent;

FIG. 3A shows a graph of powder X-Ray diffraction data of a calcined form an example spinel sorbent, and FIG. 3B shows powder X-ray data of the protonated form of the spinel sorbent of FIG. 3A showing peak positions;

FIG. 4 shows a graph of observed and calculated X-ray diffraction traces of an example spinel sorbent;

FIG. 5 shows a thermogravimetric analysis (TGA) graph of calcined form of example spinel sorbent;

FIG. 6 shows a powder X-Ray diffraction stacked overlay graph of calcined form of an example spinel sorbent;

FIG. 7 shows powder X-Ray diffraction stacked overlay graph of protonated form of an example spinel sorbent;

FIG. 8 shows a powder X-Ray diffraction graph of an example spinel sorbent comprising a mixture of lithium managanese oxide and manganese oxide (Mn₂O₃) compounds;

FIG. 9 shows a graph of powder X-Ray diffraction patterns of the spinel sorbent of FIG. 8 after acid treatment; and

FIG. 10 illustrates a schematic flow chart of an example method for separating a spinel sorbent from a liquid.

### DETAILED DESCRIPTION

This disclosure relates to selective removal of lithium ion (Li⁺) from liquid, such as high salinity brines, using a combination of unique sorbent structure and improvements in lithium ion-exchange process. A sorbent compound may be provided having a structure and chemical stoichiometry which provide improved ion-exchange for removing lithium from liquids such a brine. More specifically, a sorbent may be provided to selectively extract lithium ion from brines, leachate solutions from leaching of minerals, or recycled materials containing various competing cations and anions such as Na⁺, K⁺, B³⁺, Sr²⁺, Ca²⁺, Mg²⁺, OH⁻, Cl⁻, F⁻, NO³⁻.

Although terms such as “maximize”, “minimize” and “optimize” may be used in the present disclosure, it should be understood that such term may be used to refer to improvements, tuning and refinements which may not be strictly limited to maximal, minimal or optimal.

The terms “preferably,” “preferred,” “prefer,” “optionally,” “may,” and similar terms are used to indicate that an item, condition or step being referred to is an optional (not required) feature of the invention.

The term “substantially” as used herein may be applied to modify any quantitative representation which could permissibly vary without resulting in a change in the basic function to which it is related.

Terms such as “up to”, “at least”, “greater than”, “less than”, “more than”, “or more”, and the like, include the number recited and such terms refer to ranges that can be subsequently broken down into sub-ranges. In the same manner, all ratios recited herein also include all sub-ratios falling within the broader ratio.

The singular forms “a,” “an,” and “the” include the plural reference unless the context clearly dictates otherwise. The term “and/or” means any one of the items, any combination of the items, or all of the items,: with which this term is associated.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

The term “average oxidation state of Manganese (Mn)” as used herein reference to the average of the oxidation numbers for Mn in spinel sorbents described herein.

Aspects of various embodiments are described through reference to the drawings.

In an aspect, a sorbent sorbent for adsorbing lithium ions from a liquid is provided. The sorbent may be a lithium manganese oxide arranged in a spinel structure having a cubic close packed (CCP) lattice, with a general chemical formula of:
Li₁₊ₓMn_{2-y}M¹ₘ₁M²ₘ₂ . . . M^{k}ₘₖO_{4+z} and their alloys,
wherein:
M¹, M², . . . , M^{k} are cations different than lithium or manganese which may be selected from the group consisting of alkaline earth metals, transition metals such as Mg, Al, Fe, Cu, Ag, Sn, V, Ni, Co, Ti, Si or Zn or their combinations;
m1, m2, . . . mk are each greater than or equal to 0;
x can vary in the range of 0 and 1;
y can vary in the range of −0.1 and 0.9;
z can vary in the range of −2 and 1;
where y=x+m1+m2+ . . . +mk; and
k is a positive integer.

The sorbent may comprise a cubic close packed (CPP) lattice defining a interplanar distance configured to allow passage of lithium ions through the interplanar distance and prevent passage of manganese through the interplanar distance; and the sorbent having ion exchange sites, each ion exchange site configured to reversibly ion-exchange a lithium ion. In an embodiment, the cubic close packed (CPP) lattice may be a simple cubic structure, a body-centered cubic structure, or a face-centered cubic structure (fcc).

The reaction mechanism of spinel sorbent compounds according to this disclosure may be pH driven reversible ion-exchange process that occurs on the sorbent which may create a concentrate solution that is enriched in Li⁺ by a factor of 1-100 relative to Li⁺ concentration (mg/L) in the original liquid, e.g. brine.

In an embodiment, M¹, M², . . . , M^{k} comprise at least one of transition metals and alkaline earth metals. In another embodiment, M¹, M², . . . , M^{k} comprise at one of Mg, Al, Fe, Cu, Ag, Sn, V, Ni, Co, Ti, Si, or Zn, or combinations thereof.

In an embodiment, the Mn species with different oxidation states may including at least one of MnO (Mn²⁺), Mn₂O₃ (Mn³⁺), Mn₃O₄ (Mn²⁺, Mn³⁺).

The structure of spinel sorbent according to disclosure may have Li⁺ cations occupying tetrahedral sites and an approximately equal proportion of Mn ions present at the octahedral sites in the cubic close packed (CCP) lattice. This spacing may create a tunnel like arrangement in which Li+ is reversibly ion-exchanged.

In an embodiment, spinel sorbent may comprise Li, Mn and have at least one crystalline phase. Powder X-Ray diffraction and reitveld refinement statistics has shown example spinel sorbent(s) according to this disclosure may have a unit cell parameter of about (Å)=8.117 and a unit cell volume V (Å³) of about 534.9.

Distance between two planes in the CCP lattice of spinel sorbent may have a unique spacing, known as interplanar distance, which may be determined by powder X-Ray diffraction. In an example, the interplanar distance may be in the range of 0.01-0.46 nm, more preferably between 0.01-0.2 nm, most preferably, 0.01-0.1 nm.

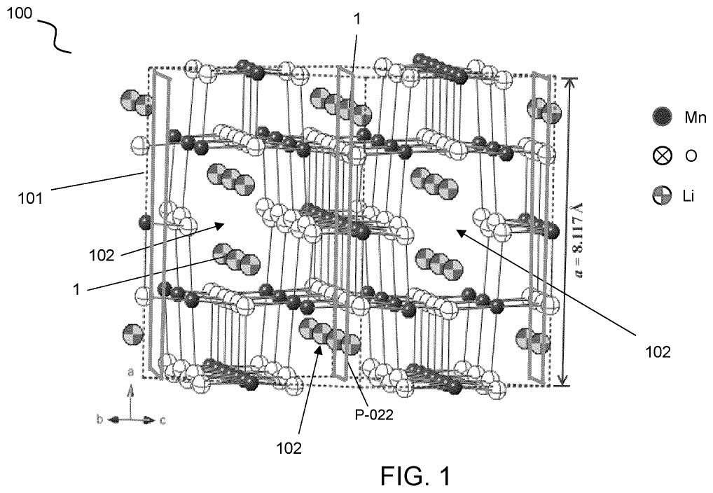

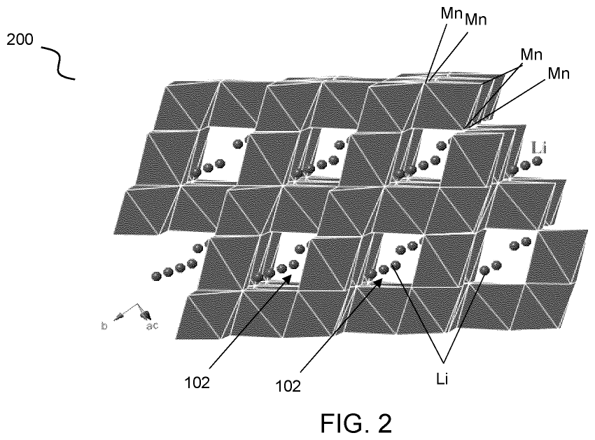

“Intercalation distance” or “tunnel radius” is the space that an ion has to migrate within spinel sorbents according to this disclosure. In an embodiment, a spinel sorbent may defined a tunnel which may have an intercalation distance smaller than the interplanar distance of the sorbent. An intercalation distance smaller than the interplanar distance may allow Li+ to ion-exchange selectively in and out of the spinel structure of a sorbent compound according to this disclosure. Example interatomic bond distance Li—O, Mn—O, bond angles, atom position coordinates x,y,z in the CCP lattice described in Tables 2 and 3 below and illustrated in FIGS. 1 and 2, which may provide improved selectivity and extraction of Li+ from a liquid containing other ions.

FIG. 1 shows a ball and stick representation of an example spinel sorbent according to this disclosure. The ball and stick representation of FIG. 1 shows a crystal structure of a lithium manganese oxide 100 with multiple unit cells 101 stacked in space, showing roughly rectangular areas 102 in the two layers of manganese octahedra (manganese bonded with six oxygen atoms). As shown, rectangular areas 102 may provide a tunnel spacing available for Li atoms 1 to migrate through the spinel sorbent which may be shorter than the interplanar distance as it may be a 3D tunnel connecting LiO₄ tetrahedra and MnO₆ octahedra which only allows Li⁺ ion in and out of the lattice during the ion exchange and may prevent other ion(s) in a liquid, e.g. brine, from accessing ion exchange sites in the lattice of the spinel sorbent when the sorbent is in contact with the liquid. As such, embodiments of the spinel sorbent may have a CCP lattice comprising a LiO₄ tetrahedra site connected to a MnO₆ octahedra site for allowing passage of lithium ions through the interplanar distance of the CCP lattice to prevent any other ion in the brine from accessing ion exchange sites in the lattice.

FIG. 2 shows a polyhedral representation an example spinel sorbent according to this disclosure having a crystal structure of lithium manganese oxide, showing three-dimensional 1×3 tunnel-like features where 3 MnO6 octahedra's are shared by 1 Li-4 tetrahedra. In FIG. 2, three octahedral are shared by 1 LiO4 which is not illustrated to simplify the figure. Mn octahedra positions of the spinel sorbent are illustrated forming adjacent repeating units arranged to defined tunnel-like feature(s) 202.

In an example, Li⁺ may have the smallest ionic radius (0.076 nm) of the ions in an example liquid from with lithium ions are to be extracted. Vacant reaction sites, i.e. sites onto which Li+ may be adsorbed in the CCP lattice of spinel sorbent according to this disclosure, may not ion-exchange with larger radius cations such as Na⁺ (0.102 nm), K⁺ (0.138 nm) Ca²⁺ (0.100 nm) Mg²⁺ (0.079 nm) when the spinel sorbent is in the liquid. Due to the intercalation distance and/or interplanar distance having an area large enough to allow Li+ to pass through to an interior of the spinel sorbent, e.g. to a tunnel like structure defined by the spinel sorbent, but small enough to prevent cations other than Li⁺ (due to their large ionic radii) to be excluded from entering the lattice of the spinel sorbent. In an example, spinel sorbent described herein may have an intercalation distance and/or interplanar distance larger than an Li⁺ interstitial atom (0.076 nm radius) but smaller than a Mg²⁺ atom (0.079 nm). Moreover, Li⁺ has lower enthalpy of hydration (−475 KJ/mol) compared to Mg²⁺ (−1980 KJ/mol) and therefore it has less tendency to remain hydrated in solution and prefer to enter the tunnel sites than Mg²⁺ ion.

After Li⁺ is adsorbed onto the reaction sites of a spinel sorbent according to this disclosure, the reaction sites may be regenerated to desorb the Li⁺. Regeneration of the ion exchange sites may occur by acid regeneration, i.e. pH driven regeneration. During the acid regeneration, in presence of protons (e.g. H⁺ ions), the Li⁺ are desorbed from the reaction sites of the spinel sorbent leading to vacancies which are exchanged by H⁺. Li⁺ may then be concentrated in the regenerant solution. The spinal structure may remain stable even after Li⁺ ions are removed from the framework and can be reused to extract Li⁺ again by re-exchanging between H⁺⇄Li⁺ leading to resorption of Li⁺ at the vacant sites.

For extraction/Li adsorbing, in an embodiment, pH for the extraction/Li adsorbing is 8.0 at 20 deg C. In another embodiment, pH for extraction/Li adsorbing is in a range of 8.0-10.0.

For desorption of Li⁺ from a spinel sorbent described herein, in an embodiment, pH range may be −0.5 to 7.0. In another embodiment, pH for desorption of Li+ may be in the range of 0.1 to 4.0 at 20 deg C. In an example, 0.5 M H₂SO₄ having a pH of 0.29 may be used to desorb Li+ from the sorbent.

The structure of the spinel sorbent may provide improved chemical stability so that the spinel sorbent may go through multiple Li+ adsorption and Li+ desorption cycles without the structure of the spinal sorbent breaking down. In an embodiment, a relative ratio of ion exchange to redox sites for manganese, Mn⁴⁺/Mn³⁺, is in a range of 2-25.

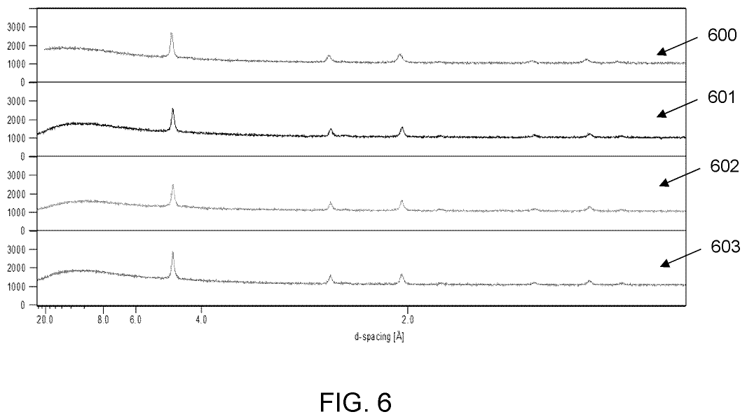

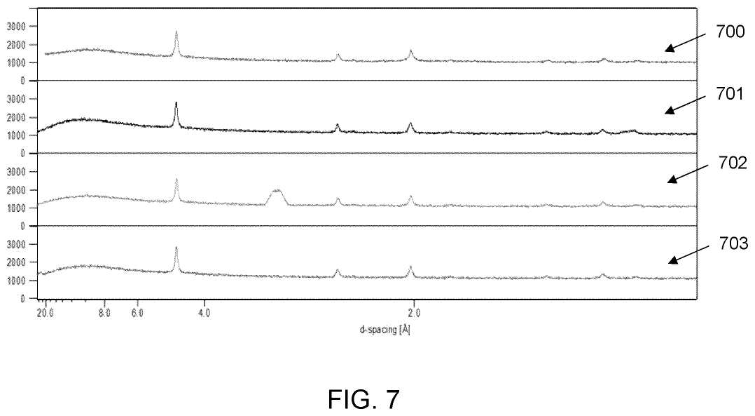

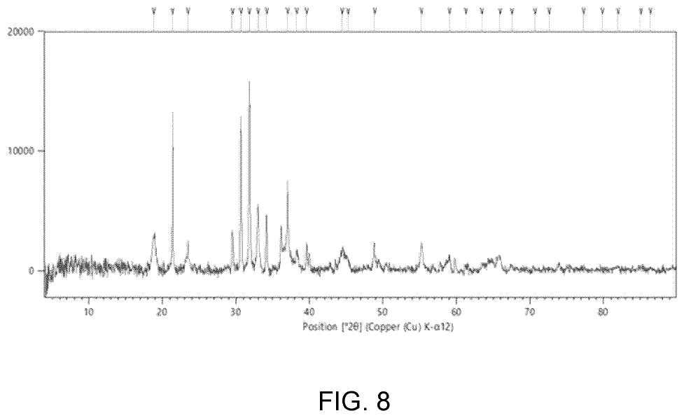

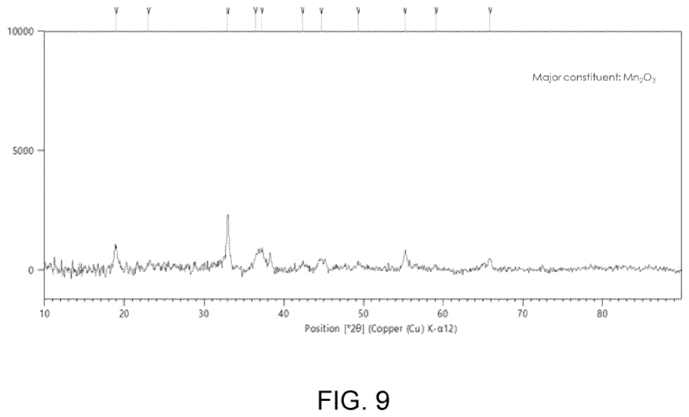

A higher oxidation state may allow sorbent compounds described herein to be regenerated longer minimizing sorbent degradation. In an illustrative example, FIGS. 6 and 7, show powder X-ray diffraction of a spinel sorbent according to this disclosure. Each peak shown in FIGS. 6 and 7 represents a position of a gap in the lattice having an intercalation distance to allow Li+ through the lattice of the spinel sorbent. As discussed below, the example spinel sorbent of FIGS. 6 and 7 may undergo multiple cycles of Li+ adsorption/acid regeneration without noticeable degradation of the chemical structure or decrease in Li+ adsorption/desorption. In another illustrative example, FIG. 8 shows a powder X-Ray diffraction of spinel sorbent formed from a mixture comprising of lithium managanese oxide and manganese oxide (Mn₂0₃) compounds. Each peak shown in FIG. 8 represents a position of a gap in the lattice having an intercalation distance to allow Li+ through the lattice of the spinel sorbent. However, continuing this illustrative example of FIG. 8, after adsorption and regeneration, the spinel sorbent may chemically degrade resulting in reduced Li+ adsorption in each subsequent adsorption cycle. FIG. 9 shows powder X-Ray diffraction patterns of the spinel sorbent of FIG. 8 after acid treatment illustrating lesser peaks indicating chemical breakdown of the spinel sorbent and collapse of the intercalation distances shown in FIG. 8. It is postulated that during acid regeneration, Mn may be dissolved during acid treatment of the spinel sorbent.

In some embodiments, for improved lithium uptake after acid regeneration, higher percentage of Mn⁴⁺ sites of spinel sorbents according to this disclosure are desired over Mn³⁺ and Mn²⁺ sites because Mn⁴⁺ contributes to the ion-exchange reaction. If compounds like MnO, Mn₂O₃, Mn₃O₄ are present in starting materials (reagents), or final spinel sorbent post-calcination the spinel sorbent may be chemically unstable and degenerate after acid regeneration.

Lithium concentration in a calcined form of spinal sorbent according to this disclosure may vary. Doping a spinel sorbent with Li+ may provide more ion exchange site which may improved adsorption efficiency of the sorbent. In an example, a spinel sorbent may comprise an amount of lithium in its calcined form of which only about 5.58 wt % is protonated. However, continuing the example, only 80-90% of the 5.58 wt % that is protonated may adsorb Li+ when exposed to brine. As such, it is postulated that by increasing Li content of the spinel sorbent (i.e. doping sorbent with Li), more ion exchange sites may be created which may increase adsorption efficiency and the absolute amount of Li+ adsorbed from a brine per molecule of sorbent. In some embodiments, the lithium concentration (in wt %) inside a calcined form of a spinel sorbent according to this disclosure is in the range of 1-50 wt %. In other embodiments, lithium concentration (in wt %) inside the sorbent is in the range of 1-30 wt %, or 1-10 wt %. Similarly, manganese concentration inside the spinel sorbent may also vary. In some embodiments, the managanese concentration (in wt %) inside the spinel sorbent is in the range of 20-90 wt %. In other embodiments, the managanese concentration (in wt %) inside the spinel sorbent is in the range of 40-80 wt %, or in other embodiment is in the range of 40-70 wt %.

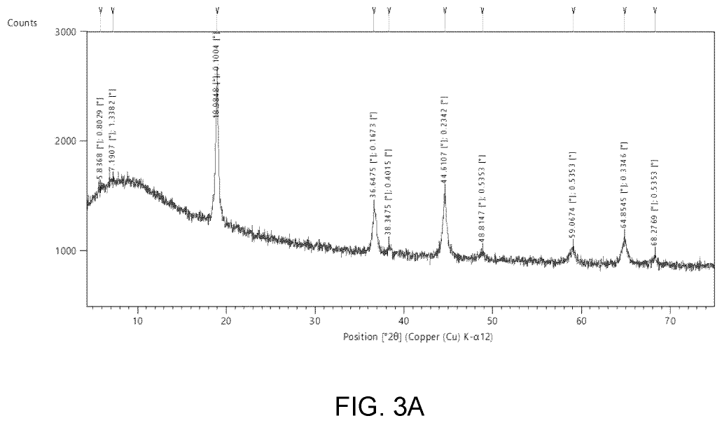

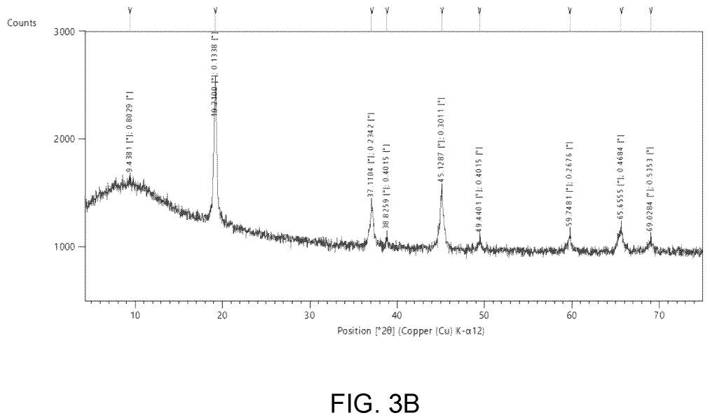

Spinel sorbent according to this disclosure is a crystalline material in the calcined (C) form which may be well-defined crystalline peaks which may shown in powder X-Ray diffraction data. In an example, FIG. 3A shows powder X-Ray diffraction data of a calcined form an example spinel sorbent using a 2theta scan from 5 degrees-75 degrees.

Spinel sorbent according to this disclosure is also a crystalline material in the protonated (H) form which may have well defined crystalline peaks which may be shown in the powder X-Ray diffraction data. In an example, FIG. 3B shows powder X-ray data of the protonated form of the spinel sorbent of FIG. 3A showing peak positions. In the example of FIG. 3B, a 2theta scan from 5 degrees-75 degrees was used. The protonated form of the spinel sorbent is obtained after acid treatment of the calcined form, which as shown when comparing FIG. 3A and 3B, was found to be stable and retain the majority of crystalline peaks which is an indication of generally only an ion-exchange type behavior.

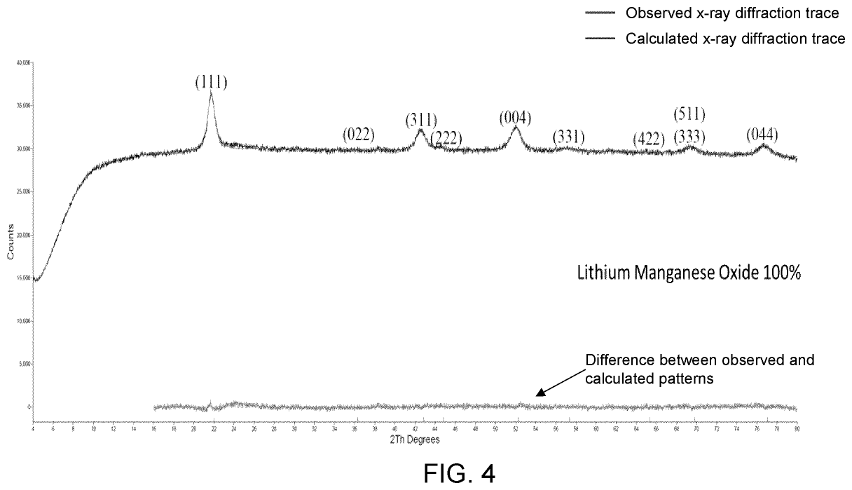

FIG. 4 shows observed and calculated X-ray diffraction traces (blue and red lines, respectively) of spinel sorbent in calcined form according to this disclosure, a 2theta scan from 5 degrees-80 degrees. The lower curve shows the difference between the observed and calculated patterns. The XRD data shows the miller indices of observed reflections and peak positions illustrating a periodic arrangement of lattice planes of atoms in the crystal structure demonstrating interplanar distances and pathways for Li+ to reach reaction sites within the spinel sorbent.

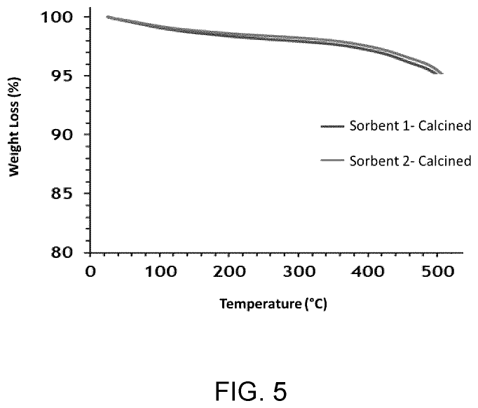

Spinel sorbent according to this disclosure may have a thermally stable structure in calcined form. FIG. 5 illustrates a thermogravimetric analysis (TGA) of calcined form of example spinel sorbent according to this disclosure. Sorbent 1 shown in FIG. 5 is the same sorbent illustrated in FIG. 3A. As shown in FIG. 5, two example sorbents according to this disclosure were weighted during calcining to illustrate weight loss on each calcined sample during a slow heating rate of 3° C./min. The weight loss in the sample ranged from 2.1-2.5 wt % which is attributed to free and bound water on the surface of sorbent in the temperature range of 150-450° C. In this example, the calcined form of sorbent may be thermally stable up to 450° C. As shown, when calcined, sorbent according to this disclosure may have minimal weight loss as a function of temperature.

Spinel sorbent according to this disclosure may have a chemically stable structure. FIG. 6 illustrates powder X-Ray diffraction stacked overlay of calcined form of an example sorbent according to this disclosure, with extracted samples after each of three cycles of Li+ adsorption and acid regeneration. As shown, the XRD pattern of the calcined spinel sorbent without extraction 600 is shown in the top row; 1st extraction 601 after one adsorption/acid regeneration cycle is shown in the second row from top, 2nd extraction 602 after a second adsorption/acid regeneration cycle is shown in the third row from top; and a 3rd extraction 603 after a third adsorption/acid regeneration cycles is shown in the fourth row from top. Sorbent digestion in the acid was done after each extraction and desorption to determine Mn losses. To quantity Mn losses from the spinel sorbent, X-Ray diffraction (XRD) was performed after each extraction-desorption step to investigate if there are any structural changes in the sorbent structure using powder crystallography. As shown in FIG. 6, to calculate Mn loss in desorption, sorbent structure after each extraction was used. In the illustrated example, FIG. 6 shows minimal change between structure of the sorbent after each cycle and Lithium ion uptake in each cycle was the same. Comparison of the XRD patterns of calcined sorbent 600 (top row) with the extracted samples; 1st extraction 601 (second row from top), 2nd extraction 602 (third row from top), and 3rd extraction 603 (fourth row from top) did not show any significant difference, all showing a spinel structure of LiMnO illustrated in FIG. 6.

FIG. 7 illustrates powder X-Ray diffraction stacked overlay of protonated form of an example sorbent according to this disclosure, with desorbed samples. Comparison of the XRD patterns of protonated form 700 (top row) with the desorbed samples; 1st desorption 701 (second row from top), 2nd desorption 702 (third row from top), and 3rd desorption 703 (fourth row from top) did not show any significant difference demonstrating the spinel structure of the spinel sorbent is preserved. In the example, 2nd desorption 702 pattern showed a wide peak at the position of 2.9Å which appears to be an equipment error as upon repetition of analysis, it disappeared in 3rd desorption 703 as shown in FIG. 7.

A spinel sorbent according to this disclosure may be made from a mixture of lithium and manganese oxide compounds. The calcination step may comprise various process variables such as heating rate, absence of air (inert atmosphere) vs air, air flow rate, calcination temperature. Methods of making spinel sorbent according to this disclosure, including calcining and various process variables thereof, are described in PCT/CA2021/051782, filed on Dec. 10, 2021, the disclosure of which is incorporated by reference herein. In an example, the products of calcination can belong to a series of compounds and mixtures thereof such as MnO, Mn₂O₃, Mn₃O₄, LiMn₂O₄, and stochiometric combinations of mixtures comprising of Li, Mn, O elements.

In an aspect, spinel sorbents according to this disclosure may be directed to a spinel sorbent which may calcined and acid treated after obtaining the calcined form. The sorbent may be a mix of Mn₂O₃ and LiMnO phases as shown in FIG. 8.

FIG. 8 illustrates powder X-Ray diffraction of a spinel sorbent comprising a mixture of lithium managanese oxide and manganese oxide (Mn₂O₃) compounds. Each peak shown in FIG. 8 represents a lattice plane which in turn points to a position of a gap in the lattice having an intercalation distance to allow Li+ through the lattice of the spinel sorbent. Acid treatment of the example spinel sorbent shown in FIG. 8 reduces the major phase to be Mn₂O₃. In this example, the protonated form may not be stable chemically and shows a redox type behavior where Mn seems to be dissolved during acid treatment. As such, after adsorption and acid regeneration, the spinel sorbent may chemically degrade resulting in reduced Li+ adsorption in each subsequent adsorption cycle.

FIG. 9 shows powder X-Ray diffraction patterns of the spinel sorbent of FIG. 8 after acid treatment illustrating lesser peaks indicating chemical breakdown of the spinel sorbent and collapse of the intercalation distances shown in FIG. 8. The major constituent of the sorbent of FIG. 9 was Mn₂O₃. Despite the chemical breakdown of the spinel sorbent, the sorbent of FIGS. 8-9 may still be used to adsorb Li+ from a liquid, e.g. brine, and desorb the Li+ during acid regeneration; however, each successive acid regeneration of the spinel sorbent may lead to further chemical breakdown of the sorbent.

### Example Data—d Spacing, Atomic Coordinates, Interatomic Distances, and Bond Angles

From the XRD data shown in FIG. 4 for the calcined form of the spinel sorbent, the prominent peak positions appeared at specific diffraction angles [2 theta, °] and interplanar distance (d-spacing, Å), were determined and are shown in Table 1 below. The peak positions are unique to a compound and provide details about the crystalline phase of the material. An example lattice plane P-022 is illustrated in FIG. 1 which corresponds with lattice plane (022) of Table 1 below. As shown in FIG. 1, lattice plane P-022 may prevent Li+ ions from migrating across the plane (i.e. from left-to-right in FIG. 1) rather Li+ may migrate through areas 102 which may provide a tunnel spacing to ion exchange sites within the lattice of the sorbent. The interplanar distance is calculated from the peak diffraction data and is an indicator of spacing between two adjacent planes (h, k, l) in a family along the orientation a, b, c. Miller indices h, k, l are shown in FIG. 4.

TABLE 1
The d spacing (Å) of different planes

| Sorbent | 2 Theta [°] | Lattice Plane | d-Spacing (Å) |
|---|---|---|---|
| Calcined form of | 21.99 | (111) | 4.68 |
| sorbent (FIG. 4) | 36.30 | (022) | 2.87 |
| | 42.85 | (311) | 2.45 |
| | 44.86 | (222) | 2.34 |
| | 52.28 | (004) | 2.03 |
| | 57.38 | (331) | 1.86 |
| | 65.31 | (422) | 1.66 |
| | 69.82 | (511) | 1.56 |
| | 77.08 | (044) | 1.43 |

Atomic coordinates in a,b,c coordinate system and isotopic displacement parameters were calculated from crystal structure refinement using the Rietveld method as shown in Table 2.

TABLE 2
Atomic coordinates

| | Atomic Coordinates | | |
|---|---|---|---|
| Atoms | x | y | z |
| Li | 0.125 | 0.125 | 0.125 |
| Mn | 0.5 | 0.5 | 0.5 |
| O | 0.26155 | 0.26155 | 0.26155 |

From the sorbent crystal structure, interatomic distances and bond angles were estimated using X-Ray diffraction data. Table 3 shows the selected interatomic distances and bond angles for Li—O, Mn—O, O—Li—O, O—Mn—O.

TABLE 3
Interatomic distances and bond angles

| Bonds | | Distances (Å) | Angles (°) |
|---|---|---|---|
| Li—O | x4 | 1.920 | |
| Mn—O | x6 | 1.940 | |
| O—Li—O | x4 | | 109.471 |
| O—Mn—O | x4 | | 84.335 |
| | x2 | | 95.665 |

### Example Data—Performance

Embodiments of spinel sorbents according to this disclosure were evaluated to test performance during extraction-desorption using crystallographic data obtained from the X-Ray diffraction. The spinel sorbents manufactured under different lab conditions whose XRD data is shown in FIGS. 3A, 8, 9 were evaluated towards their performance in a batch test using field brine.

The table 4 shows the scale and reagents, conditions, yield, Li/Mn mol ratio in calcined sorbent, are shown below.

TABLE 4

| Sorbent | | | Li/Mn |
|---|---|---|---|
| Example | Reagents | Conditions | ratio |
| Example 1 | lithium | Heated the reaction | 0.82 |
| (FIG. 3A) | acetate and | mixture at 115° C. | |
| | managanese | for 45 minutes, | |
| | nitrate | stirring (125 rpm) | |
| | | and air flow rate | |
| | | 1 Lpm, calcined | |
| | | mixture at 450° C. | |
| | | for 12 hr | |
| Example 2 | lithium | Grinding LiOH for | 0.88 |
| (FIG. 8) | hydroxide | 2 h in a rotary | |
| | and | mill, addition of | |
| | managanese | MnCO₃ and grinding | |
| | carbonate | for another 2 h. | |
| | | Drying and | |
| | | calcination, | |
| | | ramp rate: 3° C./ | |
| | | min, T = 450° C. | |
| | | for 12 h | |
| Example 3 | lithium | Acid treated for | 0.03 |
| (FIG. 9) | hydroxide | 1 h at a fixed | |
| | and | solid: liquid ratio | |
| | managanese | | |
| | carbonate | | |

Table 5 shows the extraction-desorption performance under batch tests correlated with the properties of sorbent after calcination and XRD data.

TABLE 5

| | Li | Li | Li | |
|---|---|---|---|---|
| | capacity | extraction | desorption | Li/Mn |
| Sorbent | (mg Li/g | recovery | recovery | (mol) in |
| Example | sorbent) | (%) | (%) | desorbent |
| Example 1 | 31 | 91 | 92 | 14.3 |
| (FIG. 3A) | | | | |
| Example 2 | 7 | 21 | 22 | 1.5 |
| (FIG. 8) | | | | |

Table 6 shows the extraction-desorption performance under batch tests correlated with the properties of sorbent as shown by their XRD diffraction patterns shown in FIGS. 6 and 7 that underwent multiple cycle testing during extraction-desorption performance evaluation. Sorbent digestion was done after each extraction and desorption to determine the sorbent structure after each step. Therefore, to calculate Mn loss in desorption, 10 sorbent structure after each extraction was used. As shown in table 6, lithium capacity, extraction, and recovery remained was nearly unchanged during multiple cycle testing and a high recovery of Li in the extractant and desorbent media.

TABLE 6

| | Li Capacity | Li Extraction | Li Recovery in |
|---|---|---|---|
| Cycle # | (mg Li/g sorbent) | Recovery (%) | Desorbent (%) |
| Cycle-1 | 21 | 92.6 | 100 |
| (measured after | | | |
| 701 in FIG. 7) | | | |
| Cycle-2 | 21 | 92.6 | 100 |
| (measured after | | | |
| 702 in FIG. 7) | | | |
| Cycle-3 | 21.7 | 92.9 | 97.5 |
| (measured after | | | |
| 703 in FIG. 7) | | | |

Additional embodiments of spinel sorbents according to this disclosure were prepared and evaluated to test performance during extraction-desorption. Table 7 shows the exemplary spinel sorbents. Table 8 shows the extraction-desorption performance of the sorbents of Table 7.

TABLE 7

| | | Based on moles of starting material | | | |
|---|---|---|---|---|---|
| | | | | moles | |
| | additional | moles | moles | additional | Li/Mn |
| Example | element(s) | Li | Mn | element(s) | ratio |
| 4 | | 1.33 | 1.67 | | 0.8:1 |
| 5 | | 1.10 | 1.00 | | 1.1:1 |
| 6 | | 1.50 | 1.00 | | 1.5:1 |
| 7 | | 3.00 | 1.00 | | 3.0:1 |
| 8 | Nickel | 0.80 | 1.00 | 0.06 | 0.8:1 |
| 9 | Cobalt | 0.80 | 1.00 | 0.02 | 0.8:1 |
| 10 | Nickel + Cobalt | 0.80 | 1.00 | 0.06 + 0.02 | 0.8:1 |
| 11 | Aluminum | 0.80 | 1.00 | 0.10 | 0.8:1 |
| 12 | Vanadium | 0.80 | 1.00 | 0.22 | 0.8:1 |
| 13 | Boron | 1.10 | 1.00 | 0.08 | 1.1:1 |
| 14 | Magnesium | 1.10 | 1.00 | 0.03 | 1.1:1 |
| 15 | Nickel | 1.10 | 0.95 | 0.03 | 1.17:1 |
| 16 | Nickel | 1.10 | 0.87 | 0.06 | 1.27:1 |

In Table 7, Example 4 is a spinel sorbent formed using LiOH·H₂O and MnCO₃ as the reagents, provided in amounts to result in a theoretical formula of Li₄Mn₅O₁₂. The lithium was provided as particles with a median particle size of about 3 μm. The manganese was provided as particles with a median particle size of about 40 μm. The lithium and manganese particles were mixed using a roller mixer mill for about 2 hours. The resulting mixture was heated in an oxidizing atmosphere by injecting air at a flow rate of 1 standard litre per minute (SLPM) at a ramp rate of about 3° C./minute until a calcination temperature of about 450° C. was reached. The mixture was calcined in the oxidizing atmosphere at 450° C. for about 6 hours, and allowed to cool at a cooling rate of about 6° C./minute until room temperature. The resulting material was sieved using −30/+500 mesh sieve.

Examples 5 to 16 were prepared using similar methods, but using amounts of LiOH·H₂O and MnCO₃ to result in the noted Li/Mn ratios, and using amounts of Ni₃CO₃·5H₂O (Examples 8 and 10), Co(NO₃)₂·6H₂O (Examples 9 and 10), Al(OH)₃ (Example 11), V₂O₅ (Example 12), H₃BO₃ (Example 13), Mg(NO₃)₂·6H₂O (Example 14), or NiCO₃·H₂O (Example 15 and 16) to result in the noted moles of the additional element(s). In examples 6, 7, 8, 10, 11, and 12, after the 2 hours of mixing discussed above, the reagents were additionally mixed for 15 minutes using 12 mm alumina grinding balls.

The sorbent of Example 4 had a loose bulk density of 0.88 g/cm³. The sorbent of Example 5 had a loose bulk density of 1.03 g/cm³. The sorbent of Example 6 had a loose bulk density of 0.99 g/cm³. The sorbent of Example 8 had a loose bulk density of 0.94 g/cm³.

TABLE 8

| | Protonation | | | | | | |
|---|---|---|---|---|---|---|---|
| | | Mass of | | | | | |
| | | Mn loss | | | Desorption | | |
| | % | on | Extraction | | Li | | |
| | Lithium | sorbent | Extraction | Li uptake | stripping | Li | |
| | stripped | basis | efficiency | (mg Li/g | efficiency | recovery | Mn loss |
| Example | (W %) | (W %) | (%) | sorbent) | (%) | (%) | (W %) |
| 4 | 81.0% | 3.4% | 49.0% | 18.5 | 132.0% | 64.7% | 2.1% |
| 5 | 70.8% | 1.3% | 49.1% | 18.4 | 139.2% | 68.4% | 0.7% |
| 5.1 | 69.5% | 1.3% | 45.5% | 17.1 | 133.1% | 60.6% | 0.8% |
| 5.2 | | | 56.3% | 21.1 | 92.3% | 52.0% | 1.0% |
| 6 | 62.2% | 0.9% | 44.2% | 16.6 | 150.8% | 66.7% | 0.8% |
| 6.1 | 61.9% | 0.9% | 40.8% | 15.3 | 148.9% | 60.7% | 0.6% |
| 6.2 | | | 55.6% | 20.8 | 93.1% | 51.7% | 0.8% |
| 7 | 42.8% | 0.3% | 14.4% | 5.4 | 298.2% | 42.8% | 0.3% |
| 8 | 78.5% | 2.5% | 56.3% | 21.1 | 107.0% | 60.3% | 1.9% |
| 9 | 73.8% | 2.5% | 53.3% | 20.0 | 103.2% | 55.0% | 1.9% |
| 10 | 66.3% | 2.6% | 39.7% | 14.9 | 142.5% | 56.5% | 3.0% |
| 11 | 82.0% | 2.8% | 46.2% | 17.3 | 109.7% | 50.7% | 1.7% |
| 12 | 73.1% | 6.4% | 35.2% | 13.2 | 112.3% | 39.5% | 4.1% |
| 13.1 | 79.2% | 2.3% | 60.8% | 22.8 | 108.0% | 65.7% | 1.5% |
| 13.2 | | | 56.9% | 21.3 | 90.6% | 51.6% | 2.0% |
| 14.1 | 80.6% | 0.9% | 58.5% | 21.9 | 115.1% | 67.3% | 0.8% |
| 14.2 | | | 55.8% | 20.9 | 93.2% | 52.0% | 1.2% |
| 15.1 | 78.6% | 1.9% | 53.7% | 20.2 | 115.4% | 62.0% | 1.5% |
| 15.2 | | | 59.0% | 22.1 | 87.7% | 51.7% | 1.5% |
| 16.1 | 85.2% | 1.6% | 53.7% | 20.1 | 118.9% | 63.9% | 1.5% |
| 16.2 | | | 60.6% | 22.7 | 89.3% | 54.1% | 1.5% |

In the batch tests for Table 8, the protonation step (to form a protonated form of the sorbent compound) was conducted using 0.5 M H₂SO₄ as the eluent and sufficient sorbent and acid to result in a ratio of 10:1 g sorbent/L acid. The sorbent was treated with the acid for about 1 hour at room temperature. The extraction step was conducted using a lithium-containing brine, and sufficient sorbent and brine to result in a ratio of 2:1 g sorbent/L brine. The sorbent was treated with the brine for about 15 minutes at about 70° C. The lithium concentration in the brine was 75 mg/L. The desorption step was conducted using 0.5 M H₂SO₄ as the eluent and sufficient sorbent and acid to result in a ratio of 40:1 g sorbent/L acid. The sorbent was treated with the acid for about 15 minutes at room temperature.

In Table 8, some exemplary sorbents were tested in a single-cycle test (identified as “example #”). Some exemplary sorbents were alternatively or additionally tested in a two-cycle test (with the first cycled identified as “#.1” and the second cycled identified as “#.2”). In the two-cycle test, the sorbent was first subjected to the protonation, extraction, and desorption steps, and then subsequently subjected a second time to the extraction and desorption steps.

In Table 8: (i) the expression “% lithium stripped” refers to the amount of lithium removed from the sorbent divided by the amount of lithium initially present in the sorbent; (ii) the expression “mass of Mn loss on sorbent basis” refers to the amount of manganese in the protonation supernatant after the protonation step divided by the mass of the sorbent before the protonation; (iii) the expression “extraction efficiency” refers to the amount of lithium absorbed by the sorbent divided by the initial amount of lithium in the brine; (iv) the expression “lithium uptake” refers to the amount of lithium absorbed by the sorbent divided by initial mass of the sorbent; (v) the expression “lithium stripping efficiency” refers to the amount of lithium in the desorption supernatant after the desorption divided by the amount of lithium on the sorbent before the desorption; (vi) the expression “lithium recovery” refers to the lithium stripping efficiency multiplied by the extraction efficiency; and (vii) the expression “Mn loss” refers to the amount of manganese in the desorption supernatant after the desorption divided by the mass of the sorbent before the desorption.

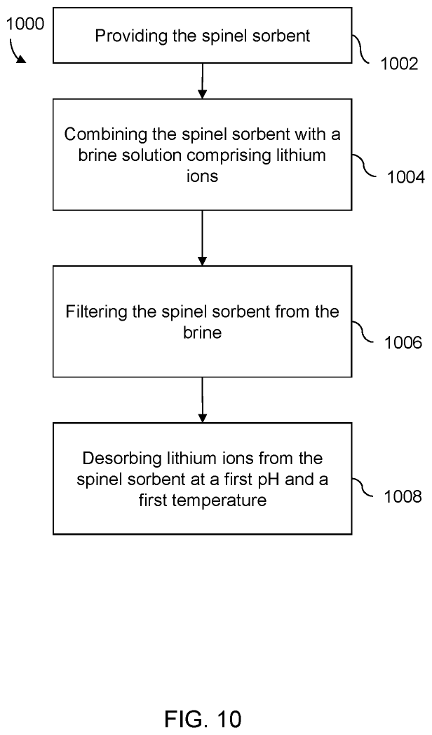

FIG. 10 illustrates a schematic flow chart of an example method for separating a spinel sorbent from a liquid (e.g. brine). In an aspect, method 1000 for extracting lithium ions from a liquid is provided. At block 1002, example method 1000 comprises providing a spinel sorbent according to this disclosure.

In an embodiment, at block 1004, the spinel sorbent may be combined with a liquid comprising lithium ions. In an example, the liquid may be brine. Lithium ions may be extracted from the liquid by adsorbing lithium ion on the spinel sorbent at a pH of about 4.0-10.0. In another example, the lithium may be adsorbed on the spinel sorbent at a pH of 6.0-10.0 at 20 deg C. The pH of the liquid may be the pH of the brine which may be adjusted to optimize adsorption of lithium ion on the spinel sorbent.

In an embodiment, at block 1006, the spinel sorbent may be filtered from the liquid.

In an embodiment, at block 1008, lithium ions may be desorbed from the spinel sorbent at a pH and a temperature which may be a pH of a desorbent, e.g an acidic desorbent, configured to exchange H+ with Li+. In an example, the method may comprise exchanging H+ with Li+ at ion exchange sites of the spinel sorbent. The pH may be about −0.5-7.0. In another example, the pH is about 0.1-4.0 at 20 deg C.

### Manufacturing Spinel Sorbent

Spinel Sorbent according to this disclosure may be made according to the methods described in PCT/CA2021/051782, filed on Dec. 10, 2021, the disclosure of which is incorporated by reference herein.

In an aspect, a method of making a spinel sorbent is provided, the method comprising: i) mixing, in a solid state or in a slurry state, a lithium-containing compound, a manganese compound, optionally a compound with another element from the periodic table in a given stochiometric ratio; ii) dry pulverizing one of the reagents or mixture to achieve a certain particle size; iii) performing heat-treatment; iv) wet size classification post heat-treatment; iv) acid treatment; v) rinsing the excess reagent off the sorbent surface; vi) drying the sorbent material; vii) heat treatment of the dried sorbent material and degassing.

In an example, a method for making a spinel sorbent comprises mixing at least one manganese precursor powder (MPP) and at least one lithium precursor power (LPP) to form a precursor powder mixture (PPM). In an embodiment, at least one larger particle size MPP (e.g. manganese salt and/or oxide powder) with coarse size distribution having a median particle size greater than about 1 μm, e.g. in the range about 1-5,000 μm, together with a coarser particle size distribution wherein at least about 50%, more preferably 75%, and most preferably 90% of the particles are larger than at least 1 μm, preferably 1 μm, more preferably 40 μm, and most preferably 100 μm is mixed with a smaller particle size lithium salt and/or oxide powder (lithium precursor powder (LPP)) having a median particle size smaller than the MPS of the MPP and in the range of about 0.5-500 μm. The LPP may be milled, e.g. by a roller mill to a desired particle size. For example, LiOH may be milled from 60 μm to less than 20 μm. The LPP MPS is preferably 0.5-15 μm, preferably below 10 μm, more preferably below, 5 μm and most preferably below 2 μm. In some embodiments, rhodochrosite phase of MnCO₃ may be used as an MPP which may have a particle size in a range of 50-1000 μm which may provide a similarly sized spinel sorbent. Larger sized MPP, e.g. greater than 10 μm, may provide a spinel sorbent that is rich in ion exchange sites. Example larger particle size MPP include rhodochrosite phase of MnCO₃ or large size synthetic manganese carbonate reagent (d50>=10 micron). Rhodochrosite phase of MnCO₃ may have a MPS of greater than 100 μm and may comprise FeCO₃ and other transition metal ion carbonates. Any lithium precursor power (LPP), may be combined with rhodochrosite phase of MnCO₃ to for the precursor powder mixture. For example, anhydrous LiOH may be used.

In various embodiments, the ratio of the MPP MPS to the LPP MPS may be from about 40:1 to about 5:1, such as from about 20:1 to about 10:1. In an embodiment, the MPP MPS may be about 40 μm and the LPP MPS may be about 3.0 μm.

In an embodiment, the precursors powders are mixed together at a Li: Mn molar ratio of 1:4 to 3:1, such as a ratio of 0.5:2 to 2:1, such as about 0.8:1.0; about 1.1:1; about 1.17:1, about 1.27:1, about 1.5:1, or about 3.0:1. In other embodiments, the precursors powders are mixed together at a Li:Mn molar ratio of 0.7:1 to 1.1:1 or 1.1:1 to 3.0:1.

Exemplary manganese salts and oxides include MnO₂, Mn₂O₃, Mn₃O₄, MnCO₃, MnCO₃ (Rhodochrosite Phase), MnSO₄, Mn(NO₃)₂, MnOOH, Mn(CH₃CO₂)₂, and mixtures thereof.

Exemplary lithium salts and oxides include Li₂O, LiOH, LiOH·H₂O, LiNO₃, Li₂CO₃, Li₂SO₄, LiNO₃, LiCH₃CO₂ (lithium acetate), and mixtures thereof.

Exemplary compounds with another element from the periodic table include NiCO₃·5H₂O (nickel carbonate basic hydrate); Ni(NO₃)₂; Co(NO₃)₂·6H₂O; CoCO₃·H₂O (cobalt carbonate hydrate); CoCO₃; Al(NO₃)₃·9H₂O (aluminum nitrate nonahydrate); Al(OH)₃; V₂O₅; H₃BO₃; Mg(NO₃)₂·6H₂O; and mixtures thereof.

The MPPs may be purchased or sieved, centrifuged, or otherwise reduced in size and/or classified to meet the larger median particle size and coarser particle size distribution described by this disclosure.

The LPPs may be purchased or are micronized, milled in a ball mill, planetary ball mill, fluid jet mill, roller mill or other mill, possibly containing a mixing media added to break up agglomerates, for 30 minutes to 12 hours, most preferably 7 hours to produce a lithium salt and/or oxide powder with a MPS smaller than the manganese salt and/or oxide powder.

The manganese salt and/or oxide powder and lithium salt and/or oxide powder mixture may be thoroughly mixed manually, with a stirrer, in a roller mill, or other mixer. In an example, after the PPM is formed, the PPM may be introduced into a roller mill and roller milling to form a roller mill precursor mixture (RMPM).

In various embodiments, additives, such as complexing agents and/or oxidants are not required in the methods and spinel sorbents describe herein. As such, the PPM and resulting sorbents may be free of additives such as complexing agents and/or oxidants.

Continuing the example method for making a spinel sorbent, the method comprises calcining the PPM for a time sufficient to form a spinel sorbent. The spinel sorbent may have a median particle size (MPS) greater than 1 μm. During calcining, the LPP may decompose into an intermediary which may bond with MnₐO_{b} (where MnₐO_{b} is an intermediate compound of the MPP and/or LPP formed during calcining). In an example, LiOH may decompose into Li₂O which may bond with MnₐO_{b} during calcination. In an embodiment, the MPS is greater than or equal to 10 μm. In other examples, the spinel sorbent may have an MPS in a range of 1-5000 μm, 2-100 μm, 10-50 μm, or greater than 50 μm. In an example, after thorough mixing, the powdered mixture is placed in a furnace (tube, muffle or other) for calcination under airflow to form the spinel sorbent compound having a large median particle size and coarse particle size distribution approximately equivalent to the manganese salt and/or oxide described above. In an example, the air flow is circulated at a rate in a range of 0-10 litres per minute (LPM). Calcining the powdered mixture may be conducted in a range of 200-800° C. In an embodiment, the powdered mixture may be calcinated at 400-500° C., such as at 450° C. The calcination temperature may be arrived at by heating the powdered mixture at a ramp rate of about 2° C./minute to about 5° C./minute, such as a ramp rate of about 3° C./minutes. Calcination time may range from 1-24 hours, such as about 4 hours, about 6 hours, about 8 hours, or about 10 hours. After the calcination, the calcined material may be cooled at a cooling rate of about 4° C./minute to about 10° C./minute, such as a cooling rate of about 6° C./minute. Spinel sorbent made from rhodochrosite phase of MnCO₃ as MPP may have a MPS of greater than 100 μm and may comprise FeCO₃ and other transition metal ion carbonates which may require longer calcination time. Notably, in comparison to sorbent made from synthetic MnCO₃, sorbent made from rhodochrosite phase of MnCO₃ according to this disclosure shrinks less in size during calcination resulting in a an spinel sorbent with a larger comparative particle size.

Continuing the example method for making a spinel sorbent, after calcination, the spinel sorbent compound may be mixed with an acid to exchange Li⁺ ion for H⁺ ion, thereby forming a protonated form of the sorbent compound which can be used to extract lithium from a liquid source by exchanging a H⁺ ion from the spinel sorbent compound with a Li⁺ ion from the liquid source.

Treatment with the liquid source exchanges H⁺ ions for Li⁺ ions in the protonated form of the sorbent composition through ion exchange. Adsorbed lithium in the sorbent is released by treatment with acid to re-exchange H⁺ ions for Li⁺ ions and to regenerate the sorbent.

The treatment (Li⁺ ion adsorption) step and desorption/regeneration (Li⁺ desorption) step may each require separation of the sorbent solid from the liquid source and desorption fluid, respectively.

### Alternate Embodiments

The above description is meant to be exemplary only, and one skilled in the relevant arts will recognize that changes may be made to the embodiments described without departing from the scope of the invention disclosed. The present disclosure may be embodied in other specific forms without departing from the subject matter of the claims. The present disclosure is intended to cover and embrace all suitable changes in technology. Modifications which fall within the scope of the present invention will be apparent to those skilled in the art, in light of a review of this disclosure, and such modifications are intended to fall within the appended claims. Also, the scope of the claims should not be limited by the preferred embodiments set forth in the examples, but should be given the broadest interpretation consistent with the description as a whole.

What is claimed is:

1. A spinel sorbent for adsorbing lithium ions from a liquid, the sorbent comprising: 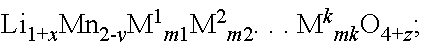
wherein:
M¹, M², . . . , M^{k} are cations different than lithium or manganese;
m1, m2, . . . mk are each greater than or equal to 0;
x is in the range of 0 and 1;
y is in the range of −0.1 and 0.9;
z is in the range of −2 and 1;
where y=x+m1+m2+ . . . +mk; and
k is zero or a positive integer;
the sorbent having a cubic close packed (CPP) lattice defining a interplanar distance configured to allow passage of lithium ions through the interplanar distance and prevent passage of manganese through the interplanar distance; and
the sorbent having ion exchange sites, each ion exchange site configured to reversibly ion-exchange a lithium ion.

2. The spinel sorbent of claim 1, wherein M¹, M², . . . , M^{k} comprise at least one of transition metals and alkaline earth metals.

3. The spinel sorbent of any one of claims 1-2, wherein M¹, M², . . . , M^{k} comprise at one of Mg, Al, Fe, Cu, Ag, Sn, V, Ni, Co, Ti, Si, or Zn, or combinations thereof.

4. The spinel sorbent of any one of claims 1-3, wherein the interplanar distance is 0.01-0.46 nm.

5. The spinel sorbent of claim 4, wherein the interplanar distance is 0.01-0.2 nm.

6. The spinel sorbent of claim 4, wherein the interplanar distance is 0.01-0.1 nm.

7. The spinel sorbent of any one of claims 1-6, wherein Li⁺ cations occupy tetrahedral sites of the CCP lattice and an equal proportion of Mn ions occupy octahedral sites of the CCP lattice.

8. The spinel sorbent of any one of claims 1-7, wherein the CCP lattice defines a tunnel, the ion exchange sites facing the tunnel.

9. The spinel sorbent of claim 8, wherein an intercalation distance of the tunnel is smaller than the interplanar distance.

10. The spinel sorbent of claim 9, wherein the CCP lattice comprises a LiO₄ tetrahedra site connected to a MnO₆ octahedra site for allowing passage of lithium ions through the interplanar distance of the CCP lattice and prevents any other ion in the liquid from accessing ion exchange sites in the lattice.

11. The spinel sorbent of any one of claims 1-10, wherein the Mn of the spinel sorbent comprises species having different oxidation states including at least one of MnO (Mn²⁺), MnO₂ (Mn⁴⁺), Mn₂O₃ (Mn³⁺), Mn₃O₄ (Mn²⁺, Mn³⁺).

12. The spinel sorbent of any one of claims 1-11, wherein the cubic close packed (CPP) lattice is a simple cubic structure, a body-centered cubic structure, or a face-centred cubic structure (fcc).

13. The spinel sorbent of any one of claims 1-12, wherein in a calcined form the spinel sorbent comprises 1-50 wt % lithium.

14. The spinel sorbent of claim 13, wherein the spinel sorbent comprises 1-30 wt % lithium.

15. The spinel sorbent of claim 13, wherein the spinel sorbent comprises 1-10 wt % lithium.

16. A spinel sorbent for adsorbing lithium ions from a liquid, the sorbent formed from calcining a mixture of a lithium precursor powder, a manganese precursor powder, and at least one additional compound selected from Ni₃CO₃·5H₂O, Ni (NO₃)₂, Co(NO₃)₂·6H₂O, CoCO₃·H₂O, CoCO₃, Al(NO₃)₃·9H₂O, Al(OH)₃, V₂O₅, H₃BO₃, Mg(NO₃)₂·6H₂O, and any combination thereof.

17. The spinel sorbent according to claim 16, wherein the lithium precursor powder is a LiOH·H₂O powder; and/or the manganese precursor powder is a MnCO₃ powder.

18. The spinel sorbent according to claim 16 or 17, wherein the lithium precursor powder and the manganese precursor powder are present in amounts that provide lithium and manganese at a molar ratio from about 1:4 to about 3:1, for example from about 0.8:1 to about 3.0:1, of Li:Mn.

19. The spinel sorbent according to any one of claims 16 to 18, wherein the at least one additional compound is present in an amount that provides the Ni, Co, Al, V, B, Mg, or combination thereof in an amount from 0.02 to 0.22 moles for every 1.8 to 2.1 total moles of lithium plus manganese.

20. The spinel sorbent according to any one of claims 16 to 19, wherein the ratio of (a) the median particle size of the manganese precursor powder to (b) the median particle sizes of the lithium precursor powder, is from about 40:1 to about 5:1, such as from about 20:1 to about 10:1.

21. The spinel sorbent according to claim 20, wherein the median particle size of the manganese precursor powder is about 40 μm and the median particle size of the lithium precursor powder is about 3.0 μm.

22. The spinel sorbent according to any one of claims 16 to 21, wherein the calcining includes holding the reagents at a temperature from about 400° C. to about 500° C., such as at about 450°° C., for a period of time from about 1 to about 24 hours, such as from about 4 hours to about 10 hours, for example for about 6 or about 8 hours.

23. The spinel sorbent according to any one of claims 16 to 22, wherein the calcining includes heating the reagents at a ramp rate of about 2° C./minute to about 5° C./minute, such as a ramp rate of about 3° C./minutes; and/or cooling the calcined material at a cooling rate of about 4° C./minute to about 10° C./minute, such as a cooling rate of about 6° C./minute.

24. The spinel sorbent according to any one of claims 16 to 23, wherein the calcining is performed in an oxidizing environment.

25. The spinel sorbent of any one of claims 16 to 24, wherein the sorbent has a cubic close packed (CPP) lattice defining a interplanar distance configured to allow passage of lithium ions through the interplanar distance and prevent passage of manganese through the interplanar distance.

26. The spinel sorbent of claim 25, wherein the interplanar distance is 0.01-0.46 nm.

27. The spinel sorbent of claim 26, wherein the interplanar distance is 0.01-0.2 nm.

28. The spinel sorbent of claim 26, wherein the interplanar distance is 0.01-0.1 nm.

29. The spinel sorbent of any one of claims 25 to 28, wherein Li+ cations occupy tetrahedral sites of the CCP lattice and an equal proportion of Mn ions occupy octahedral sites of the CCP lattice.

30. The spinel sorbent of any one of claims 25 to 29, wherein the CCP lattice defines a tunnel, the ion exchange sites facing the tunnel.

31. The spinel sorbent of claim 30, wherein an intercalation distance of the tunnel is smaller than the interplanar distance.

32. A method comprising:
providing the spinel sorbent of any one of claims 1 to 31;
combining the spinel sorbent with a liquid comprising lithium ions;
filtering the spinel sorbent from the liquid; and
desorbing lithium ions from the spinel sorbent at a first pH and a first temperature.

33. The method of claim 32, comprising exchanging H⁺ with Li⁺ at ion exchange sites of the spinel sorbent.

34. The method of any one of claims 32 to 33, wherein the first pH about −0.5-7.0.

35. The method of claim 34 wherein the first pH is about 0.3-4.0 at 20-100 deg C.

36. The method of any one of claims 32 to 35, comprising adsorbing lithium ion on the spinel sorbent at a second pH of about 4.0-10.0.

37. The method of claim 36, wherein the second pH is 6.0-10.0 at 20-85 deg C.

38. The method of any one of claims 32 to 37, comprising combining the spinel sorbent with a second liquid comprising lithium ions, filtering the spinel sorbent from the second liquid; and desorbing lithium ions from the spinel sorbent after filtering the spinel sorbent from the second liquid.

39. The method of claim 38, wherein the first liquid is the same as the second liquid.
